(19) United States
(12) Patent Application Publication
(10) Pub. No.: US 2016/0025593 A1
(43) Pub. Date: Jan. 28, 2016

(54) Detection of Stuck Plate Valve of Gaseous Engine

(71) Applicant: Southwest Research Institute, San Antonio, TX (US)

(72) Inventors: Garrett L. ANDERSON, Seguin, TX (US); Ryan C. ROECKER, Fair Oaks Ranch, TX (US)

(21) Appl. No.: 14/341,195

(22) Filed: Jul. 25, 2014

(51) Int. Cl. G01M 15/04; G01P 15/00; F02D 41/00; F02M 21/02; F02D 41/22

(52) U.S. Cl. CPC G01M 15/042; F02M 21/023; F02M 21/0293; F02M 21/0269; F02M 21/0254; F02D 41/22; F02D 41/0027; G01P 15/00; F02D 2041/224

(57) ABSTRACT

A method of detecting a stuck plate valve of a gas engine. An accelerometer is mounted on or near the valve, such that the valve is operable to detect the closing and/or opening of the valve. A detection unit stores values representing the output of the accelerometer when the valve is operating normally. During operation of the engine, the detection unit receives current output from the accelerometer, and compares the current output with the stored values to determine whether the valve is operating normally.

### TECHNICAL FIELD OF THE INVENTION

This invention relates to engines that use large plate valves, such as large natural gas and dual fuel engines, and more particularly to detection of a stuck plate valve in such engines.

### BACKGROUND OF THE INVENTION

Many gas-fueled engines use large solenoid-operated plate valves to admit gas into the intake port of each cylinder. Such engines include large natural gas and dual-fuel engines.

The plate valves are open for only a part of the engine cycle. If one of these valves were to become stuck open, damage to the engine or its surroundings could occur.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a cross sectional view of a plate valve equipped with an accelerometer for stuck valve detection.

FIG. 2 illustrates the voltage output of the accelerometer during normal valve closing.

FIG. 3 illustrates the voltage output of the accelerometer during a stuck valve condition.

FIG. 4 illustrates an envelope of the accelerometer output during normal valve closing.

FIG. 5 illustrates an envelope of the accelerometer output during a stuck valve condition.

### DETAILED DESCRIPTION OF THE INVENTION

The invention described herein is directed to detecting a “stuck” condition of large plate valves used in gas-fueled engines. For purposes of example, the valve is described in terms of a gas admission valve in a natural gas engine. However, the invention is applicable to any plate type valve. As explained below, a feature of these valves is that they have a hard impact upon closing, which can be detected by an accelerometer.

As used herein, a “gas engine” or “gas-fueled engine” is an engine, typically an internal combustion engine, which runs on a gaseous fuel. Examples of such engines are engines that operate on coal gas, producer gas, biogas, landfill gas or natural gas. In the United States, due to the widespread use of “gas” as an abbreviation for gasoline, such an engine might also be called a gaseous-fueled engine or natural gas engine.

For purposes of this invention, the terms “gas engine” and “gas-fueled engine” further refer to a heavy-duty industrial engine. These engines use heavy duty plate valves for gas admission into the engine cylinders. This type of gas admission valve distinguishes these larger gas engines from smaller ones, which typically use injection devices for delivering gas into the cylinders.

Because dual-fuel engines may also use similar valves, the term “gas engine” is meant to also include dual-fuel engines. The dual-fuel engines operate on both natural gas and diesel fuel simultaneously. The diesel fuel auto ignites under compression and then ignites the gas fuel.

As used herein, a “gas admission valve” is assumed to be a plate valve used to admit a desired amount of gaseous fuel into an engine cylinder. The fuel intake may be in-manifold or cylinder port fuel admission.

In a typical gas engine, one gas admission valve is used for each cylinder. The engine load and speed are governed by the amount of gas admitted into the intake port, which is proportional to the duration of the valve opening. The valve must assure rapid valve opening and closing (a fast response to the control signal) together with reliable valve opening for the desired period of time. A gas admission valve features short travel, and a complete seal in the closed position of the valve plate.

Gas admission valves are often electrically actuated, such as by being solenoid operated. Typically, the moving valve plate is opened by the solenoid force, and is closed by a spring force together with gas pressure.

An example of a gas admission valve with which the invention described herein may be used is the Solenoid Operated Gas Admission Valve (SOGAV valve) manufactured by Woodward, Inc. The SOGAV valve is especially designed for use on four-cycle, turbocharged, natural gas or dual-fuel engines.

Because gas admission valves (as used herein) are plate valves, they use at least one plate that is constrained to move within the valve bore between the valve seat and valve cover. Some plate valves have more than one plate, which cooperate to meter, open, and seal (close) the valve.

As stated above, these gas admission valves and many other plate valves typically have a very short stroke to allow them to operate very quickly. To allow for a large flow, a large plate is used which has a large mass. When this plate reaches the end of its stroke while opening or closing, it creates an impact.

The impact of the plate can be detected by an accelerometer. If the valve were to become seized or even partially seized, this impact will not be present or greatly reduced. In this manner, a valve that is stuck open or closed can be detected.

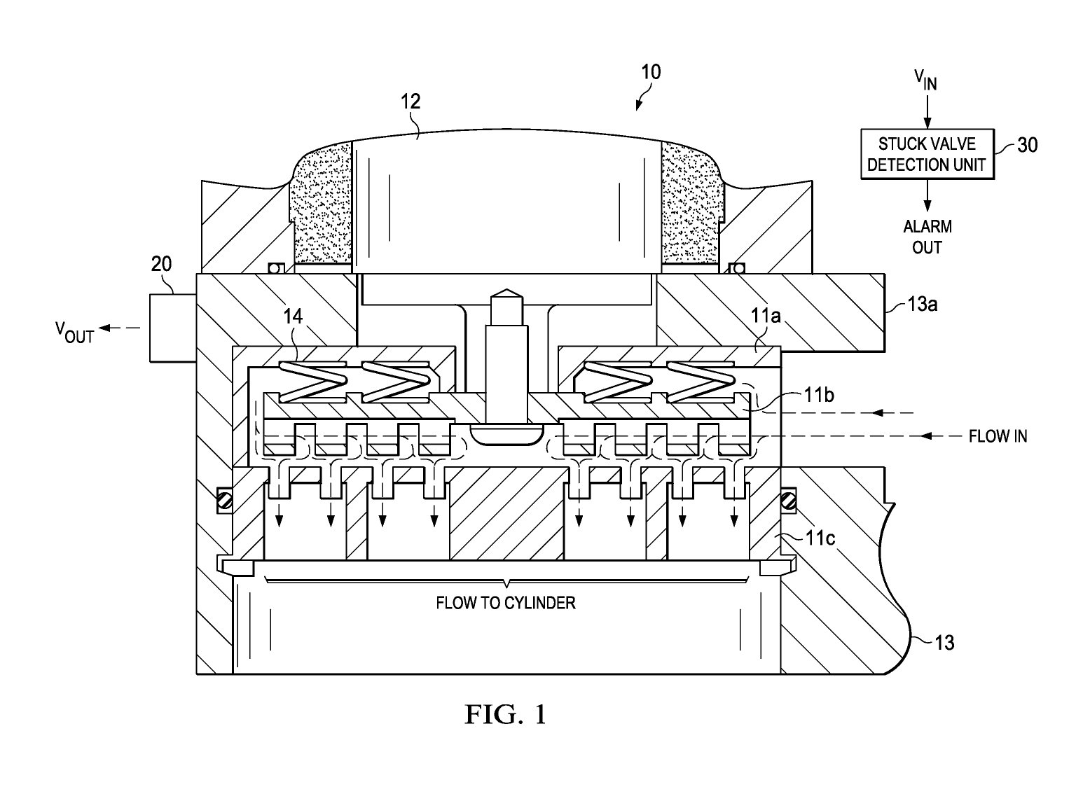

FIG. 1 illustrates a gas admission valve 10, which is equipped with an accelerometer 20 for stuck valve detection in accordance with the invention. Valve 10 is a plate valve, having three plates 11a, 11b and 11c, which cooperate to open, close and meter the amount of fuel admitted into the cylinder. Valve 10 is actuated by means of a solenoid 12. A valve housing 13 constrains the motion of the plates, and has means for attaching valve 10 to the cylinder head of the engine.

Accelerometer 20 is mounted on or near valve 10. In the example of FIG. 1, accelerometer 20 is attached to the valve housing 13 at a location near the upper (impact) range of the motion of the moving plate 11b that impacts the valve head 13a.

In the example of FIG. 1, the moving plate 11b impacts the valve head 13a via an upper plate 11a, with a set of interposed springs 14. Many other valve plate configurations are possible. A common feature is a moving plate that creates an impact upon opening and/or closing upon a valve seat or other surface, referred to herein as an “impact surface”. The accelerometer 20 is located outside the valve housing 13 in a location near the place of impact.

Accelerometer 20 may be any one of various types of accelerometers. It may be a single axis device, that is, it need only detect acceleration in the direction of movement of the opening and closing plate of valve 10. If a single axis accelerometer is used, the accelerometer is mounted such that its axis is parallel to the stroke of valve 10. The use of a triple-axis accelerometer would ease mounting alignment constraints.

Various accelerometers may be implemented with piezoelectric, piezoresistive and capacitive components, which convert mechanical motion into an electrical signal. Various microphone type sensors may also be used, such as a piezo microphones. For most applications, accelerometer 20 should be designed and housed to withstand high engine temperatures.

As shown in FIG. 1, the output of accelerometer 20 is a voltage signal, which is delivered to a stuck valve detection unit 30. As further explained below, detection unit 30 analyzes the signal to determine whether the signal is normal or whether it indicates a stuck valve. Detection unit 30 has whatever signal processing and analysis hardware and/or software as is appropriate for performing the tasks described herein.

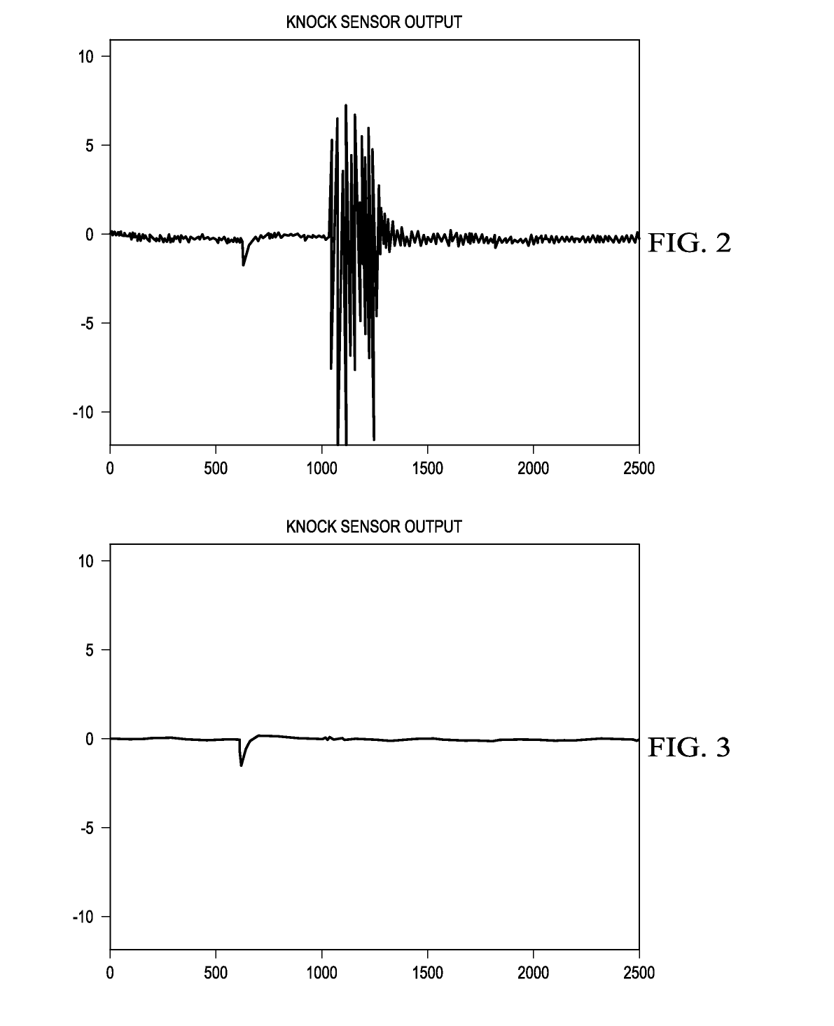

FIG. 2 illustrates an example of “normal” voltage output from an accelerometer 20 detecting a valve closing. Each engine cycle will provide a detectable valve plate impact, detected by the accelerometer 20, whose output will look similar to that of FIG. 2.

A valve opening signal would look similar, although of perhaps different amplitude and duration. In general, the valve closing (or opening) event is detected as a sharp increase in amplitude of the signal. As stated above, this is due to the impact of the valve plate upon its valve seat or other surface upon which it impacts.

FIG. 3 illustrates the output of accelerometer 20 from the same valve as in FIG. 2, and during the same portion of the engine cycle, but with the valve stuck closed. The well defined increase in amplitude of FIG. 2 is not present.

Thus, the signal amplitude from accelerometer 20 can be used to determine the operating state (normal versus stuck) of the valve 10. The output signal from the accelerometer 20 is processed by detection unit 30 to create a meaningful value that can be used by detection unit 30 to determine whether a valve is stuck or not.

This output signal could be processed in several ways. One possibility would be to detect the envelope of the filtered signal and integrate the resulting waveform. Other possibilities would be to square or take the absolute value of the signal. An integration of this signal would occur during a specified window during the engine cycle when the valve would be expected to open or close. This use of a specific window, avoids detecting other vibration caused by the engine. A reduction in this integrated value below this threshold would indicate a stuck or sticking valve.

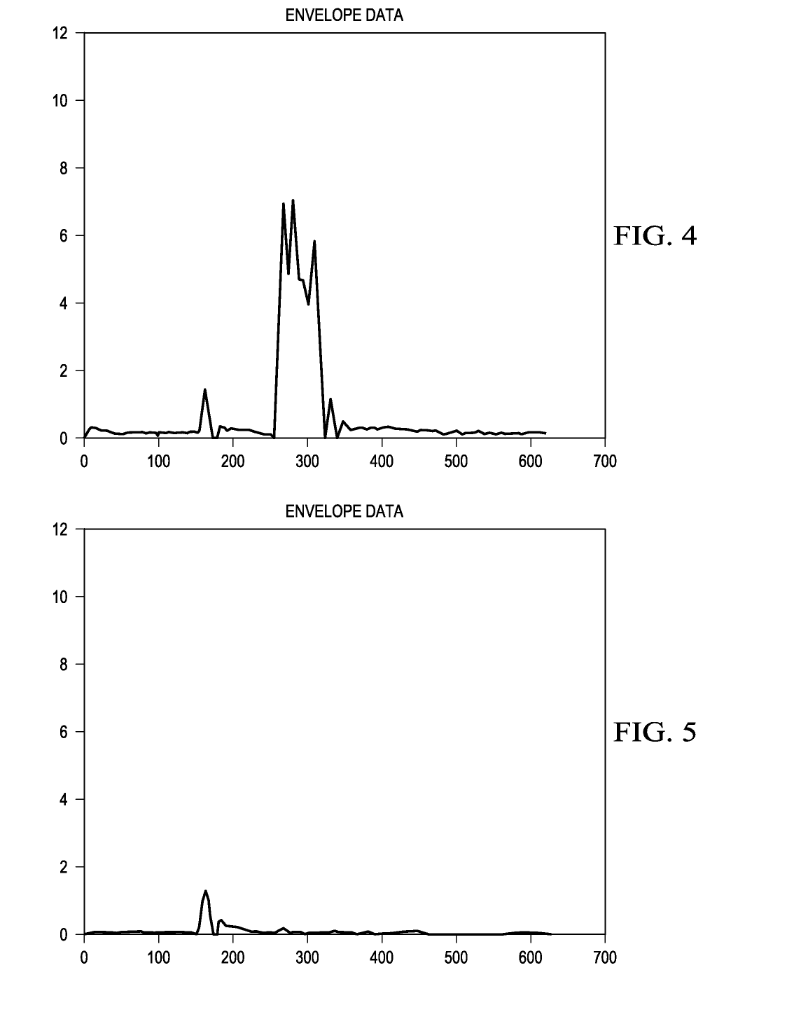

FIGS. 4 and 5 illustrate the envelope of the signal from accelerometer 20 for a normal and a stuck valve, respectively. As illustrated, the integrated or average value of the signal within the envelope is significantly lower for a stuck valve.

Referring again to FIG. 1, detection unit 30 has memory that stores threshold values representing the output of accelerometer 30 when valve 10 is operating normally. These stored values can include the timing, duration and amplitude of the output from the impact of a properly operating valve, during closing and/or opening.

For example, a threshold valve representing the voltage amplitude of a properly closing valve can be stored. As shown in FIGS. 2 and 4, for each engine cycle, a normal valve closing will be reflected by output data having expected timing, duration, and amplitude values. Additional values and values representing a properly opening valve can also be stored.

During operation of the engine, detection unit 30 receives voltage output from accelerometer 20 representing the current operation of the valve. Detection unit 20 compares the stored (expected) values, with the current output from accelerometer 20.

If any of these variables do not meet expected values, a problem with the valve 10 can be detected. For example, in FIGS. 3 and 5, it can be seen that a stuck valve will have amplitude values far below those of a normal valve.

If detection unit 30 detects a stuck valve, it can deliver an output signal representing an alarm or warning. This signal can be used by a control interface to warn an operator of the engine that a stuck valve exists.

What is claimed is:

1. A method of detecting a stuck plate valve of a gaseous engine, comprising:
mounting an accelerometer on or near the valve, such that the valve is operable to detect impacts resulting closing and/or opening of the valve;
using a detection unit to store values representing the output of the accelerometer when the valve is operating normally;
during operation of the engine, receiving current output from the accelerometer;
comparing the current output with the stored values to determine whether the valve is operating normally.

2. The method of claim 1, wherein the valve is a gas admission valve.

3. The method of claim 1, wherein the accelerometer is a single axis accelerometer with the axis mounted parallel to the direction of motion of the valve plate.

4. The method of claim 1, wherein the accelerometer is a multiple axis accelerometer.

5. The method of claim 1, wherein the accelerometer is a piezoelectric pressure sensor.

6. The method of claim 1, wherein the comparing step compares values representing normal valve opening with the current output.

7. The method of claim 1, wherein the comparing step compares values representing normal valve closing with the current output.

8. An improved plate valve of the type used on gaseous engines, the improvement comprising:
an accelerometer mounted on the valve, such that the valve is operable to detect impacts resulting from the closing and/or opening of the valve;
a detection unit having memory to store values representing the output of the accelerometer when the valve is operating normally;
wherein the detection unit has a processor programmed to receive, during operation of the engine, current output from the accelerometer, and to compare the current output with the stored values to determine whether the valve is operating normally.

9. The valve of claim 8, wherein the valve is a gas admission valve.

10. The valve of claim 8, wherein the accelerometer is a single axis accelerometer with the axis mounted parallel to the direction of motion of the valve plate.

11. The valve of claim 8, wherein the accelerometer is a multiple axis accelerometer.

12. The valve of claim 8, wherein the accelerometer is a piezoelectric pressure sensor.

13. The valve of claim 8, wherein the detection unit compares values representing normal valve opening with the current output.

14. The valve of claim 8, wherein the detection unit compares values representing normal valve closing with the current output.
